(19) United States
(12) Patent Application Publication
(10) Pub. No.: US 2005/0125300 A1
(43) Pub. Date: Jun. 9, 2005

(54) Method for adding cash value to pre-paid cards

(76) Inventors: John G. McGill, Naperville, IL (US); William J. Dupre, Downers Grove, IL (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/876,108

(22) Filed: Jun. 24, 2004

Related U.S. Application Data
(63) Continuation-in-part of application No. 10/727,783, filed on Dec. 4, 2003.

(51) Int. Cl. G06F 17/60

(52) U.S. Cl. 705/21

(57) ABSTRACT

For an organization having a central station and a plurality of distributed outlets, each of the following a cashier's terminal, each of the cashier's terminals coupled to a respective point-of-sale (POS) controller, a method of permitting an individual to add value to a pre-paid card issued by a card provider is disclosed.

### CROSS-REFERENCE TO RELATED APPLICATION

This application is a continuation-in-part of U.S. patent application Ser. No. 10/727,783 filed on Dec. 4, 2003, entitled “Method for Paying Invoices”.

### TECHNICAL FIELD

The present invention relates to a system and method of permitting an individual to add cash vale to a pre-paid card at a retail outlet, such as a grocery store.

### BACKGROUND OF THE INVENTION

Meyer et al., U.S. patent application Publication No. 2002/0128967 discloses a system where a customer pays an invoice issued by a biller, such as a utility company, at a retail location, such as a supermarket. However, this system requires that the utility's invoice includes a bar code identifying both the utility as well as the customer.

Additionally, this system requires extensive integration with the supermarket's cash register system.

Further, this system requires that the supermarket forward the payment through the Federal Reserve Automated Clearing House (ACH) Network.

Still further, this system makes no provision for charging the consumer for this service.

The present invention is provided to solve these and other problems.

### BRIEF DESCRIPTION OF THE DRAWINGS

Other advantages and aspects of the present invention will become apparent upon reading the following description of the drawings and detailed description of the invention.

FIG. 1 is a block diagram of the present invention.

FIG. 2 is a process flow diagram of one aspect of the present invention.

### DETAILED DESCRIPTION OF THE INVENTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

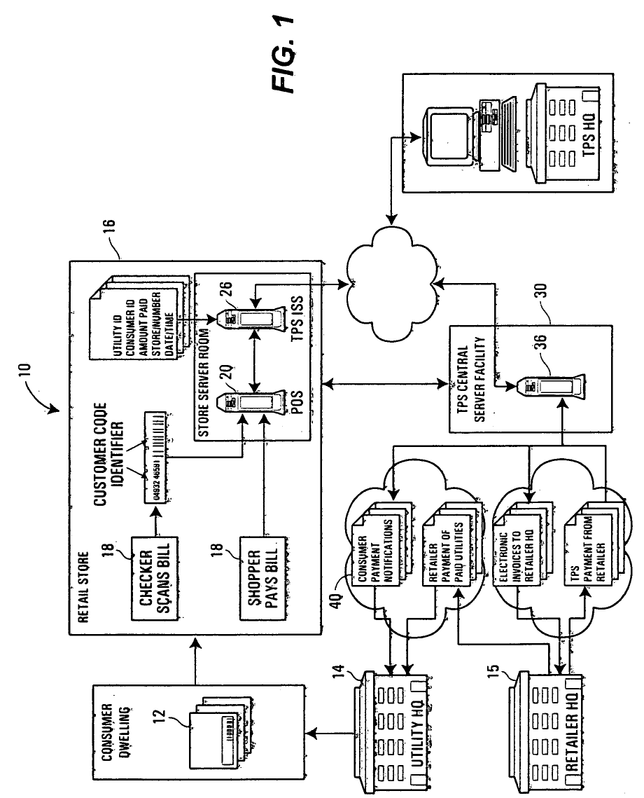

A system 10 for permitting a customer billee, such as an individual, to pay an invoice 12 generated by a biller 14, such as from a utility company, at a retail outlet of an organization, such as a retail grocery store of a grocery store chain, is illustrated in FIG. 1.

The grocery store chain has a central station 15, such as its headquarters, and a plurality of distributed outlets 16. Each of the outlets 16 typically has a plurality of cashier's terminals 18. Each of the cashier's terminals 18 is coupled to a conventional point-of-sale (POS) controller 20, which is part of the store's computer system.

The invoice 12 is issued to the customer, either by regular mail, by e-mail, or otherwise. The customer goes to the outlet 16, possibly selects various items to purchase, such as groceries, and takes the selected items, if any, and the invoice to the cashier's terminal 18.

An invoice transaction is conducted by a cashier entering data identifying the biller and the billee into the cashier's terminal 18. Specifically, the biller may be identified by entering a Product Look-Up Code (PLC) for the biller. Alternatively, the biller may be identified by scanning a bar-code identification of the biller, which bar-code could be printed on the invoice. The customer is identified by entering a customer code identifier, such as the customer's account number. This may be done either by manually entering the account number via a key pad, or by scanning a bar code on the invoice.

The cashier also enters data indicating an amount of money to be paid by the billee towards the invoice into the cashier's terminal. The billee may choose to pay some or all of the invoiced amount. This may be repeated for other invoices, as well.

If the billee also desires to purchase one or more other items from the outlet 16, an other transaction is conducted by the cashier entering data identifying the one or more other items to be purchased into the cashier's terminal 18.

The POS controller 20 determines a total amount of money due as a result of the invoice transaction and the other transaction, and the billee tenders payment for the amount due. The POS controller 20 creates an electronic transaction log including an invoice transaction record of the invoice transaction and, if one or more other items were purchased, an other transaction record of the one or more other items purchased. The POS controller 20 flags the invoice transaction record, and transmits the transaction log from the POS controller 20 to a processing server 26.

The processing server 26 strips the invoice transaction record from the transmitted transaction log, and transmits the stripped invoice transaction record from the processing server 26 to a central server 30. The central server 30 performs both a communication function as well as a payment processing function. The central server may include a single server 36 to perform these functions, or it may include one or more dedicated communication server(s) and one or more dedicated payment processing server(s). The payment processing function gathers multiple stripped invoice transaction records, relating to multiple invoice payments, to multiple billers, over a period of time.

Peridically, the central server 30 determines from the transmitted, stripped invoice transaction records, the amount of payment due to each of the particular billers, and the central server 30 electronically instructs the central station 15 to forward payment to the appropriate biller. Payment by the central station 15 to the particular billers can be done, as desired, such as by check, by wire, or otherwise.

The central server 30 also generates an electronic notification to each of the billers, indicating the amount paid by the respective billees towards their respective invoices.

The transaction log may include a plurality of transaction records, with each of the transaction records having a respective invoice transaction record and other transaction record.

In the preferred embodiment, the processing server 26 and the central server 30 are operated by a third-party. Accordingly, a service fee is added to the amount the customer wants to pay to the biller, and thus this amount is added to the total amount of money the customer tenders to the cashier. This service fee is split between the grocery chain and the third-party. To transfer the third-party's share from the grocery, which received the service fee from the customer, to the third-party, the central server 30 electronically instructs the central station 15 to pay the third-party its share. This payment can be done by check, by wire, or otherwise.

The transaction log is transmitted to the processing server on a daily basis, such as following the normal end-of-day (EOD) run.

The stripped invoice transaction record is transmitted to the central server 30 when the invoice transaction record has been stripped from the transaction log.

The stripped invoice transaction record is transmitted from the processing server 26 to the central server 30 by a direct modem connection. Alternatively, the stripped invoice transaction record is transmitted from the processing server 26 to the central server 30 by an internet connection.

In the preferred embodiment, each of the outlets 16 has a plurality of cashier's terminals 18 coupled to a respective POS controller 20.

Following the transaction, the cashier's terminal generates a receipt for the customer, identifying both payment of the utility invoice, as well as payment for the other items, if any, purchased.

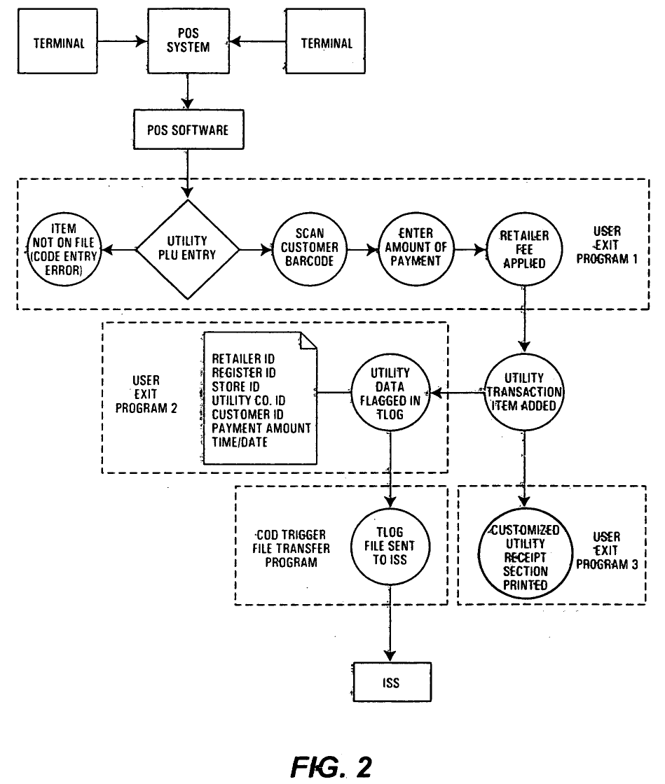

The present invention can be accomplished with no intrusion into the outlet's existing computer system, other than a minor modification of the software in the POS controller 20. These modifications will now be described with reference to FIG. 2.

A first modification is identified as User Exit Program 1. According to this modification, the POS controller software is modified to receive the PLU code of the biller issuing the invoice to be paid, and to determine the identity of the biller. If the POS controller does, not recognize the PLU code, an error message is generated. Otherwise, the POS controller receives the data identifying the customer. The POS controller then receives data identifying the amount to be paid towards the invoice, and then adds the service fee.

A second modification is identified as User Exit Program 2. According to this modification, once the utility transaction item has been added, the POS controller flags the utility transaction in the transaction log.

A third modification is identified as User Exit Program 3. According to this modification, information regarding the utility payment is added to the otherwise conventional receipt.

A fourth modification is identified as User Exit Program 4. According to this modification, the POS controller transmits the transaction log to the processing server when the conventional EOD routine is run.

In an alternative embodiment, the POS controller 20 can be modified to transmit to the processing server 26 only those transaction logs including an invoice transaction record.

In a further alternative embodiment, the POS controller 20 can be modified to transmit to the processing server 26 only the invoice transaction record.

In a still further alternative embodiment, the processing server 26 and the central server 30 can be eliminated, and the POS controller 20 is modified to directly instruct the central station 15 to pay the biller.

Additionally, the system can be used to add money value to pre-paid cards, such as phone cards, gift certificate cards, and the like.

For example, pre-paid phone cards can be activated as follows.

The cashier would use a pre-determined PLU to identify the item as a phone card and scan the identification number on the card. The information would be stored, and forwarded, to the in-store server. The server would then notify the phone card-company that the number and the amount have been activated.

Using the same method as described above, an existing card can add more minutes by informing the cashier, when prompted by the system, how much money they would like to add to the phone card.

Further, debit bank cards can be activated as follows.

The cashier would use the same identification process and when prompted would ask the consumer what dollar value they would like to put on the card. When the information is received on the in-store server, the bank would be notified that the card number has been activated and how much money was paid upon activation. This process would not require the identification of the user, just the number on the card.

Funds would be added in the same manner as the card was activated.

Pre-paid gift cards would be activated as follows.

Each pre-paid gift card type or company would have a unique PLU as an identifier. Using this PLU, the cashier would then scan the card and enter the amount of the face value of the card into the system. The central server would retrieve the card information and provide the necessary information to the appropriate company.

Using the same process, an existing pre-paid gift card can be re-activated for those companies that have a policy to permit re-activation.

The existing process enables the retailer to accept funds that are targeted for transfer to a debit card or bank account. The consumer making the deposit will be required to have a card that identifies the account the funds are to be assigned towards. When prompted, the cashier will ask the consumer how much money is to be deposited in the account. When the information is collected by the central server, the appropriate company is provide with the required account information.

Money, points, and other value-based information could also be transferred through the system

The system allows any individual or group to transfer value-based transactions, such as money, points, minutes, credits, and other key content, to other individuals or shoppers in participating stores and other locations taking part in the service. The types of units that can be transferred from one party to another are limited only by the ability the initiating party's provider (e.g. the individual's bank or credit provider) to efficiently translate the units into transportable data. The additional data can be recorded by the system, and the transactions can be completed per the above program with a variable fee amount going to the retail outlet and the third-party, the end billing units being processed by the third-party, and the final transfer of billing information executed by the third-party to the sender's resource, the store, and other involved parties.

The currency or credit provider would receive the billing messages directly from the third-party, and the transactions would be completed, authorized, and validated using the system. All settlement information would be processed through the system, and billing transfer arrangements would be handled in accordance with the guidelines set forth by the participating parties.

While the specific embodiments have been illustrated and described, numerous modifications come to mind without markedly departing from the spirit of the invention. The scope of protection is only intended to be limited by the scope of the accompanying claims.

1. For an organization having a central station and a plurality of distributed outlets, each of the outlets having a cashier's terminal, each of the cashier's terminals coupled to a respective point-of-sale (POS) controller, a method of permitting an individual to add value to a pre-paid card issued by a card provider, the method comprising:
conducting a card transaction by entering data identifying the pre-paid card into one of the cashier's terminals, and entering data indicating an amount of money to be added to the pre-paid card into the one of the cashier's terminals;
if an other item is to be purchased, conducting an other transaction by entering data identifying the other item to be purchased into the one of the cashier's terminals;
determining a total amount of money due as a result of the card transaction and the other transaction;
tendering payment for the amount due;
creating an electronic transaction log including a card transaction record of the invoice transaction;
flagging the card transaction record;
transmitting the transaction log from the POS controller to a processing server;
stripping the card transaction record from the transmitted transaction log; and
transmitting the stripped card transaction record from the intermediate server to a central server, wherein the central server determines from the transmitted, stripped card transaction record, the amount of payment due to the card provider, and instructs the central station to forward payment to the card provider.

2. The method of claim 1 wherein the central server generates a notification to the card provider indicating the amount paid by the individual towards the pre-paid card.

3. The method of claim 1 wherein the transaction log includes a plurality of transaction records, each having a respective card transaction record, which card transaction records are stripped and transmitted to the central server.

4. The method of claim 1 wherein the card transaction includes an addition of a service fee to the amount of money to be added to the pre-paid card.

5. The method of claim 4 wherein the central server instructs the central station to pay a third-party an amount of the service fee.

6. The method of claim 5 wherein the processing server is operated by the third party.

7. The method of claim 5 wherein the central server is operated by the third party.

8. The method of claim 1 wherein the data identifying the pre-paid card provider is entered as a product look-up code (PLC).

9. The method of claim 8 wherein the PLC is entered by key pad.

10. The method of claim 1 wherein the data identifying the pre-paid card is entered by scanning the pre-paid card.

11. The method of claim 10, wherein the data is entered by a bar card reader.

12. The method of claim 1 wherein the transaction log is transmitted to the processing server on a daily basis.

13. The method of claim 12 wherein the stripped card transaction record is transmitted to the central server when the card transaction record has been stripped from the transaction log.

14. The method of claim 1 wherein the stripped card transaction record is transmitted from the processing server to the central server by a direct modem connection.

15. The method of claim 1 wherein the stripped card transaction record is transmitted from the processing server to the central server by an internet connection.

16. The method of claim 1 wherein the organization is a grocery store chain.

17. The method of claim 1 wherein the each of the outlets has a plurality of cashier's terminals coupled to a respective POS controller.

18. The method of claim 1 including generating a receipt for the individual of the card transaction and the other transaction.

19. For an organization having a central station and a plurality of distributed outlets, each of the outlets having a cashier's terminal, each of the cashier's terminals coupled to a respective point-of-sale (POS) controller, a method of permitting an individual to add value to a pre-paid card issued by a card provider, the method comprising:
conducting a card transaction by entering data identifying the pre-paid card into one of the cashier's terminals, entering data indicating an amount of money to be added to the pre-paid card into the one of the cashier's terminals, and adding a service fee to the amount to be added to the card by the individual;
if an other item is to be purchased, conducting an other transaction by entering data into the one of the cashier's terminals identifying the other item to be purchased;
determining a total amount of money due as a result of the card transaction and the other transaction;
tendering payment for the amount due;
creating an electronic transaction log including a card transaction record of the card transaction;
flagging the card transaction record;
providing a third-party processing server and central server;
transmitting the transaction log from the POS controller to the processing server;
stripping the card transaction record from the transmitted transaction log; and
transmitting the stripped card transaction record from the processing server to the central server; wherein the central server determines, from the transmitted, stripped card transaction record, the amount of payment due to the card provider, instructs the central station to forward payment to the card provider, and instructs the central station to pay the third party an amount of the service fee.

20. The method of claim 19 wherein the central server notifies the card provider of the payment by the individual towards the pre-paid card.

21. The method of claim 19 wherein the transaction log includes a plurality of transaction records, each having a respective card transaction record, which card transaction records are stripped and transmitted to the central server.

22. The method of claim 19 wherein the data identifying the pre-paid card provider is entered by scanning the pre-paid card.

23. The method of claim 22 wherein the PLC is entered by key pad.

24. The method of claim 19 wherein the data identifying the pre-paid card is entered as a UPC code.

25. The method of claim 24 wherein the data is entered by a card reader.

26. The method of claim 19 wherein the transaction log is transmitted to the processing server on?a daily basis.

27. The method of claim 26 wherein the stripped card transaction record is transmitted to the central server when the card transaction record has been stripped from the transaction log.

28. The method of claim 19 wherein the stripped card transaction record is transmitted from the processing server to the central server by a direct modem connection.

29. The method of claim 19 wherein the stripped card transaction record is transmitted from the processing server to the central server by an internet connection.

30. The method of claim 19 wherein the organization is a grocery store chain.

31. The method of claim 19 wherein each of the outlets has a plurality of cashier's terminals coupled to a respective POS controller.

32. For an organization having a central station and a plurality of distributed outlets, each of the outlets having a cashier's terminal, each of the cashier's terminals coupled to a respective point-of-sale (POS) controller, a method of permitting an individual to add value to a pre-paid card issued by a card provider, the method comprising:
conducting a card transaction by entering data identifying the pre-aid card into one of the cashier's terminals, entering data indicating an amount of money to be added to the card into the one of the cashier's terminals, and adding a service fee to the amount to be paid by the individual;
if an other item is to be purchased, conducting an other transaction by entering data identifying the other item to be purchased into the one of the cashier's terminals;
determining a total amount of money due as a result of the card transaction and the other transaction;
tendering payment for the amount due;
generating an electronic transaction log including a card transaction record of the card transaction;
flagging the card transaction record;
providing a third-party processing system; and
transmitting the transaction log from the POS controller to the third-party processing system, wherein the third-party processing system strips the card transaction record from the transmitted transaction log, determines from the transmitted, stripped card transaction record, the amount of payment due to the card provider, instructs the central station to forward payment to the card provider, and instructs the central station to pay the third-party an amount of the service fee.

33. The method of claim 32 wherein the third-party processing system includes a central server and a plurality of processing servers, one of the processing servers associated with a respective one of each of the outlets.

34. The method of claim 33, wherein the intermediate server strips the card transaction record from the transmitted transaction log and then transmits the stripped card transaction record to the central server.

35. The method of claim 32 wherein the third-party processing system notifies the card provider of the amount paid by the individual to be added to the card.

36. The method of claim 32 wherein the transaction log includes a plurality of transaction records, each having a respective card transaction record, which card transaction records are stripped and transmitted to the third-party processing system.

37. The method of claim 36 wherein the third-party server instructs the central station to pay the third-party an amount of the service fee.

38. The method of claim 37 including paying the third party the amount of the service fee to be paid to the third party.

39. The method of claim 32 wherein the transaction log is transmitted to the third-party server on a daily basis.

40. The method of claim 32 wherein the stripped card transaction record is transmitted to the central server when the card transaction record has been stripped from the transaction log.

41. The method of claim 32 wherein the stripped card transaction record is transmitted from the intermediate server to the central server by a direct modem connection.

42. The method of claim 32 wherein the stripped card transaction record is transmitted from the intermediate server to the central server by an internet connection.

43. The method of claim 32 wherein the organization is a grocery store chain.

44. The method of claim 32 wherein each of the outlets has a plurality of cashier's terminals coupled to a respective POS controller.

45. For an organization having a central station and a plurality of distributed outlets, each of the outlets having a cashier's terminal, each of the cashier's terminals coupled to a respective point-of-sale (POS) controller, a method of permitting an individual to add value to a pre-paid card issued by a card provider, the method comprising:
conducting a card transaction by entering data identifying the prep-paid card into one of the cashier's terminals, entering data indicating an amount of money to be added to the pre-paid card into the one of the cashier's terminals, and adding a service fee to the amount to be added by the individual;
if an other item is to be purchased, conducting an other transaction by entering data identifying the other item to be purchased in to the one of the cashier's terminals;
determining a total amount of money due as a result of the card transaction and the other transaction;
tendering payment for the amount due;
generating an electronic transaction log including a card transaction record of the card transaction;
flagging the card transaction record;
providing a processing system; and
transmitting the transaction log from the POS controller to the processing system, wherein the processing system strips the card transaction record from the transmitted transaction log, and determines from the transmitted, stripped card transaction record, an amount of payment due to the card provider.

46. The method of claim 45 wherein the processing system includes a central server and a plurality of intermediate servers, one of the processing servers associated with a respective one of each of the outlets.

47. The method of claim 46, wherein the intermediate server strips the card transaction record from the transmitted transaction log and then transmits the stripped card transaction record to the central server.

48. The method of claim 45 wherein the processing system instructs the central station to pay the card provider the amount to be added to the card.

49. The method of claim 45 wherein the transaction log includes a plurality of transaction records, each having a respective card transaction record, which card transaction records are stripped and transmitted to the server.

50. For an organization having a central station and a plurality of distributed outlets, each of the outlets having a plurality of cashier's terminal, each of the cashier's terminals of a respective outlet coupled to a respective point-of-sale (POS) controller, a method of permitting a plurality of individuals to add value to a plurality of pre-paid cards issued by any of a plurality of card providers at any one of the cashier's terminals, the method comprising:
for each individual, conducting a card transaction at one of the cashier's terminals by entering data identifying the respective pre-paid card into one of the cashier's terminals, entering data indicating an amount of money to be added to the respective card into the respective one of the cashier's terminals, and adding a service fee to the amount to be added to the respective card;
for each individual, if an other item is to be purchased, conducting a respective other transaction by entering respective data identifying respective other item to be purchased into the respective one of the cashier's terminals;
for each individual, determining a respective total amount of money due as a result of the respective card transaction and the respective other transaction;
for each individual, tendering a respective payment for the respective amount due;
generating respective electronic transaction logs, each including a respective card transaction record of the respective card transaction;
flagging the respective card transaction record in the transaction logs;
providing a processing system; and
transmitting each of the transaction logs from the respective POS controller to the processing system, wherein the processing system strips the respective card transaction records from the respective transmitted transaction logs, and generates from the transmitted, stripped card transaction records, instructions indicating the amount of payment received from each of the individuals to the respective ones of the card providers.

51. The method of claim 50 wherein the processing system includes a central server and a plurality of processing servers, each of the processing servers associated with a respective one of the outlets.

52. The method of claim 51, wherein each of the processing servers strips the card transaction record from the respective transmitted transaction log and then transmits the stripped card transaction record to the central server.

53. The method of claim 51 wherein the central server notifies the respective card providers of the amount to be added to the respective pre-paid cards.

54. The method of claim 50, wherein the processing system is operated by a party other than the organization.

55. For an organization having a central station and a plurality of distributed outlets, each of the outlets having a cashier's terminal, each of the cashier's terminals coupled to a respective point-of-sale (POS) controller, a method of permitting an individual to add value to a pre-paid card issued by a card provider, the method comprising:
conducting a card transaction by entering data identifying the pre-paid card into one of the cashier's terminals, and entering data indicating an amount of money to be added to the pre-paid card into the one of the cashier's terminals;
determining a total amount of money due including an amount due as a result of the card transaction;
tendering payment for the total amount of money due;
creating an electronic transaction log including a card transaction record of the card transaction;
flagging the card transaction record;
transmitting the transaction log from the POS controller to a processing server;
stripping the card transaction record from the transmitted transaction log; and
transmitting the stripped card transaction record from the intermediate server to a central server, wherein the central server determines from the transmitted, stripped card transaction record, the amount of payment due to the card provider, and instructs the central station to forward payment to the card provider.

56. The method of claim 55 wherein the central server generates a notification to the card provider indicating the amount added by the individual to the card.

57. The method of claim 55 wherein the transaction log includes a plurality of transaction records, each having a respective card transaction record, which card transaction records are stripped and transmitted to the central server.

58. The method of claim 55 wherein the card transaction includes an addition of a service fee to the amount of money to be added to the card.

59. The method of claim 58 wherein the central server instructs the central station to pay a third-party an amount of the service fee.

60. The method of claim 59 wherein the processing server is operated by the third party.

61. The method of claim 59 wherein the central server is operated by the third party.

62. The method of claim 55 wherein the transaction log is transmitted to the processing server on a daily basis.

63. The method of claim 62 wherein the stripped card transaction record is transmitted to the central server when the card transaction record has been stripped from the transaction log.

64. The method of claim 63 wherein the stripped card transaction record is transmitted from the processing server to the central server by a direct modem connection.

65. The method of claim 64 wherein the stripped card transaction record is transmitted from the processing server to the central server by an internet connection.

66. For an organization having a central station and a plurality of distributed outlets, each of the outlets having a cashier's terminal, each of the cashier's terminals coupled to a respective point-of-sale (POS) controller, a method of permitting an individual to add value to a pre-paid card issued by a card provider, the method comprising:
conducting a card transaction by entering data identifying the pre-paid card into one of the cashier's terminals, entering data indicating an amount of money to be added by the individual to the card into the one of the cashier's terminals, and adding a service fee to the amount to be paid by the individual towards the card;
determining a total amount of money due including an amount due as a result of the card transaction;
tendering payment for the amount of money due;
creating an electronic transaction log including a card transaction record of the card transaction;
flagging the card transaction record;
providing a third-party processing server and central server;
transmitting the transaction log from the POS controller to the processing server;
stripping the card transaction record from the transmitted transaction log; and
transmitting the stripped card transaction record from the processing server to the central server; wherein the central server determines, from the transmitted, stripped card transaction record, the amount of payment due to the card provider,
instructing the central station to forward payment to the card provider, and
instructing the central station to pay the third party an amount of the service fee.

67. The method of claim 66 wherein the central server notifies the card provider of the payment by the individual towards the pre-paid card.

68. The method of claim 66 wherein the transaction log includes a plurality of transaction records, each having a respective card transaction record, which card transaction records are stripped and transmitted to the central server.

69. The method of claim 66 wherein each of the outlets has a plurality of cashier's terminals coupled to a respective POS controller.

70. For an organization having a central station and a plurality of distributed outlets, each of the outlets having a cashier's terminal, each of the cashier's terminals coupled to a respective point-of-sale (POS) controller, a method of permitting an individual to add value to a pre-paid card issued by a card provider, the method comprising:
conducting a card transaction by entering data identifying the pre-paid card into one of the cashier's terminals, entering data indicating an amount of money to be added to the pre-paid card into the one of the cashier's terminals, and adding a service fee to the amount to be paid by the individual;
determining a total amount of money including an amount due as a result of the card transaction;
tendering payment for the amount of money due;
generating an electronic transaction log including a card transaction record of the card transaction;
flagging the card transaction record;
providing a third-party processing system; and
transmitting the transaction log from the POS controller to the third-party processing system, wherein the third-party processing system strips the card transaction record from the transmitted transaction log, determines from the transmitted, stripped card transaction record, the amount of payment due to the card provider, instructs the central station to forward payment to the card provider, and instructs the central station to pay the third-party an amount of the service fee.

71. The method of claim 70 wherein the third-party processing system includes a central server and a plurality of processing servers, one of the processing servers associated with a respective one of each of the outlets.

72. The method of claim 71, wherein the intermediate server strips the card transaction record from the transmitted transaction log and then transmits the stripped card transaction record to the central server.

73. The method of claim 70 wherein the third-party processing system notifies the card provider of the amount added to the card by the individual.

74. The method of claim 70 wherein the transaction log includes a plurality of transaction records, each having a respective card transaction record, which card transaction records are stripped and transmitted to the third-party processing system.

75. The method of claim 74 wherein the third-party server instructs the central station to pay the third-party an amount of the service fee.

76. The method of claim 75 including paying the third party the amount of the service fee to be paid to the third party.

77. The method of claim 70 wherein each of the outlets has a plurality of cashier's terminals coupled to a respective POS controller.

78. For an organization having a central station and a plurality of distributed outlets, each of the outlets having a cashier's terminal, each of the cashier's terminals coupled to a respective point-of-sale (POS) controller, a method of permitting an individual to add value to a pre-paid card issued by a card provider, the method comprising:
conducting a card transaction by entering data identifying the pre-paid card into one of the cashier's terminals, entering data indicating an amount of money to be added by the individual towards the card into the one of the cashier's terminals, and adding a service fee to the amount to be paid by the individual towards the card;
determining a total amount of money due including an amount due as a result of the card transaction;
tendering payment for the amount due;
generating an electronic transaction log including a card transaction record of the card transaction;
flagging the card transaction record;
providing a processing system; and
transmitting the transaction log from the POS controller to the processing system, wherein the processing system strips the card transaction record from the transmitted transaction log, and determines from the transmitted, stripped card transaction record, an amount of payment due to the card provider.

79. The method of claim 78 wherein the processing system includes a central server and a plurality of intermediate servers, one of the processing servers associated with a respective one of each of the outlets.

80. The method of claim 79, wherein the intermediate server strips the card transaction record from the transmitted transaction log and then transmits the stripped card transaction record to the central server.

81. The method of claim 78 wherein the processing system instructs the central station to pay the card provider the amount paid by the individual towards the card.

82. The method of claim 78 wherein the transaction log includes a plurality of transaction records, each having a respective card transaction record, which card transaction records are stripped and transmitted to the server.

83. For an organization having a central station and a plurality of distributed outlets, each of the outlets having a cashier's terminal, each of the cashier's terminals coupled to a respective point-of-sale (POS) controller, a method of permitting an individual to add value to a pre-paid card issued by a card provider, the method comprising:
conducting a card transaction by entering data identifying the pre-paid card into one of the cashier's terminals, entering data indicating an amount of money to be added by the individual towards the card into the one of the cashier's terminals, and adding a service fee to the amount to be paid by the individual towards the card;
if an other item is to be purchased, conducting an other transaction by entering data identifying the other item to be purchased in to the one of the cashier's terminals;
determining a total amount of money due as a result of the card transaction and the other transaction;
tendering payment for the amount due;
generating an electronic transaction log including a card transaction record of the card transaction;
stripping the card transaction record from the transaction log, and determining from the transmitted, stripped card transaction record, an amount of payment due to the card provider; and
transmitting an electronic message to the central station instructing the central station to pay the card provider the amount due.

84. The method of claim 83 wherein the transaction log includes a plurality of transaction records, each having a respective card transaction record.
